(19) United States
(12) Patent Application Publication
(10) Pub. No.: US 2004/0218910 A1
(43) Pub. Date: Nov. 4, 2004

(54) Enabling a three-dimensional simulation of a trip through a region

(76) Inventors: Nelson L. Chang, Palo Alto, CA (US); Ramin Samadani, Menlo Park, CA (US)

Correspondence Address: HEWLETT-PACKARD COMPANY, Intellectual Property Administration, P.O. Box 272400, Fort Collins, CO, 80527-2400, US

(21) Appl. No.: 10/625,824

(22) Filed: Jul. 23, 2003

Related U.S. Application Data
(63) Continuation-in-part of application No. 10/427,614, filed on Apr. 30, 2003.
(63) Continuation-in-part of application No. 10/427,582, filed on Apr. 30, 2003.
(63) Continuation-in-part of application No. 10/427,649, filed on Apr. 30, 2003.
(63) Continuation-in-part of application No. 10/427,647, filed on Apr. 30, 2003.

(51) Int. Cl. H04N 5/91

(52) U.S. Cl. 386/98

(57) ABSTRACT

Techniques are disclosed for enabling a three-dimensional simulation through a region as experienced from a moving vantage point along a simulation route.

### RELATED APPLICATIONS

This patent is a continuation-in-part of, and claims priority to, the following co-pending U.S. patent applications bearing Ser. Nos.: 10/427,614; 10/427,582; 10/427,649; and 10/427,647; all of which were filed on Apr. 30, 2003, and all of which are hereby incorporated by reference in their entirety.

### BACKGROUND

Tourists and other persons visiting a region typically capture their experiences through a variety of content-bearing media. For example, some commonly available audiovisual media include photographs, videos and/or audio recordings (whether as part of a video, or otherwise) taken by the persons themselves. Many visitors also purchase commercial versions of the foregoing from vendors (e.g., picture postcards, digital images on a CD, digital video on a CD, “sounds of nature” recordings, etc.). Visitors also often purchase physical souvenirs (e.g., a paperweight, t-shirt, etc.) as a memento of the trip.

After returning home, the visitor can use the audiovisual media and his/her physical media to remember the trip. However, it is difficult to integrate the individual memories associated with different forms of media. For example, one might have taken some pictures, and bought a t-shirt, at a particularly memorable location. However, flipping through a picture album does not necessarily trigger a memory of having bought the t-shirt. Conversely, putting on the t-shirt does not necessarily suggest flipping through the photo album; and even if it does, one may have to flip through several volumes or pages before locating the right pictures.

Even when using relatively similar types of media, it can be difficult to do even simple things like re-creating the trip in chronological order. For example, suppose a husband uses a conventional camera to take pictures which are developed and placed in an album, and a wife uses a digital camera to take digital pictures which are displayed using the family's computer. If the pictures are interspersed, as they will usually be, reliving the trip in chronological order will require much jumping back and forth between the photo album and the computer screen.

Even if the visitor only has a single media type (say, still pictures) to remember a trip, still other difficulties may arise in trying to remember the trip. For example, one might have visited and photographed several different cities in a foreign country, all of which have confusingly similar names (at least to a visitor who does not speak the language). Years later, the visitor might want to plan a return visit to one of the cities, yet not be able to recognize its name or visualize its location on a map.

Some existing techniques allow one to mark the location at which a particular photograph was taken. For example, certain high-end digital cameras (e.g., the Nikon D1X) include a serial interface for connecting a global positioning satellite (“GPS”) receiver. When a picture is taken, the location is uploaded and appended to the digital image file as metadata. In this manner, each individual photo contains a record of the location where it was taken, and a user can later manually paste the photos onto their proper locations on a map, as desired. Such existing systems capture individual photos and their locations, but not the context in which the photos were acquired (e.g., the travel path). In addition, other types of media (e.g., later-acquired media, media from devices lacking built-in individual GPS interfaces, etc.) are not readily localizable.

Other existing techniques, such as digital photo album software, allow a collection of pictures to be sorted automatically, using the timestamps available in the digital images, for chronological replay. This kind of system may even accommodate the use of later-acquired media (after inserting a desired timestamp), but still lacks path context.

Other existing techniques, such as GPS-based vehicle tracking for fleet management applications, receive radio transmissions of GPS signals from moving vehicles to track their locations as a function of time. In this manner, the path of the vehicles can be recorded, perhaps even on a two-dimensional road map. However, such systems lack the ability to capture and integrate content while traversing the path, much less placing such content in a proper spatial and temporal context.

Still other existing techniques from computer animation applications (e.g., flight simulator games, etc.) allow accurate rendering of an artificial path, including media placed on the path. However, these techniques, which are directed purely at playback of pre-programmed and/or predetermined media and environments, are inapplicable to capturing an arbitrary trip, and lack the ability to capture proper temporal context.

Therefore, a market exists for a technology that allows a user to conveniently capture a trip in its proper spatial and temporal context, and to subsequently simulate a trip using the captured information.

### SUMMARY

An exemplary method for enabling a three-dimensional simulation through a region comprises: obtaining information about a path traversed by a user through a region, including a plurality of locations on the path; acquiring content associated with at least some of the locations; correlating the content with the locations; and enabling an interactive three-dimensional simulation through the region as experienced from a moving vantage point along a simulation route, including accessing a three-dimensional map for at least a portion of the region and associating the acquired content to locations on the three-dimensional map based on the correlation.

An exemplary method of simulating a trip through a region from a three-dimensional vantage point comprises: accessing information about a path traversed through a region, including a plurality of predetermined locations; accessing content associated with at least some of the locations; accessing a three-dimensional map of the region; associating at least some of the content, and at least some of the locations, with the map; determining a simulation route through the region; and displaying to a user an interactive simulation along the simulation route, including presenting content along the simulation route, as experienced from a moving vantage point.

Other exemplary aspects and embodiments are also disclosed.

### BRIEF DESCRIPTION OF THE FIGURES

FIG. 1 shows an exemplary method for recording a trip through a region, including a path and associated content.

FIG. 2A illustrates an exemplary three-dimensional map of a region.

FIG. 2B illustrates an exemplary two-dimensional map of a region.

FIG. 2C illustrates an exemplary topographic map of a region.

FIG. 3 schematically illustrates photographic, audio, and video content acquired at various locations along an exemplary traversed path.

FIG. 4 shows an exemplary electronic file suitable for use to enable a three-dimensional simulation of a simulation route through a region from a moving vantage point.

FIG. 5 shows an exemplary method for simulating a trip through a region, including a simulation route and associated content, from a moving vantage point.

FIG. 6 illustrates the display of content as rotating billboards.

FIG. 7 illustrates calculating a viewable portion of the map from an arbitrary vantage point.

FIG. 8 illustrates an exemplary collision-avoidance protocol.

### DETAILED DESCRIPTION

I. Overview

Section II summarizes and highlights certain technologies for trip recording and playback, which are described in various pending patent applications from which this application claims priority. The technologies described in this application build on, and extend the patent applications by describing various additional trip simulation techniques, related primarily to enhanced three-dimensional functionality.

More specifically, Section III describes an exemplary technique for enabling a three-dimensional simulation through a region, and Section IV describes an exemplary technique for simulating and presenting a three-dimensional simulation through the region. Finally, Section V describes various alternative aspects or embodiments, Section VI describes various exemplary applications for the techniques, and Section VII describes exemplary computer environments in which aspects of the techniques can be implemented.

II. Trip Recording and Playback Technologies

Certain technology developed by the assignee of the subject application allows the tracing of a path traversed during a trip, the recording of the path on a digital map, and the association of a variety of content-bearing media with the map at the locations at which they exist or were acquired along the traversed path. All of the foregoing is displayed on a screen, allowing the user to retrace the path taken during the trip, and presenting each content item to the user, as the user passes the location where the content was acquired. The media can include any content representable in any computer-readable format, for example, digital photos, digitized sound files, scanned-in images, images captured of physical souvenirs, etc.

According to this technology, a GPS receiver is deployed (or some other form of sensor capable of measuring location and time) with the traveler. Signals are intermittently taken using the location-measuring sensor, creating a record of locations and the times at which those locations were passed. This allows the traversed path to be uniquely represented as a series of locations as a function of time (or a series of times as a function of location). Such a traversed path is then plotted on a (typically) two-dimensional map and displayed to the user.

Any of the user's content that has a timestamp—whether provided at the time of acquisition (e.g., the timestamp embedded into an image by a digital camera) or by manual intervention of a user (e.g., a digitized image of a souvenir known to have been bought during a 12 pm lunch stop)—can also be placed in an appropriate position on the map based on interpolating from the acquired data. For example, suppose that the content was acquired at time T₂, and that the path included locations X₁,Y₁ at time T₁ and X₃,Y₃ at time T₃. Then, the location at which the content was acquired can be calculated as X₂=X₁+(X₃−X₁)*(T₂−T₁)/(T₃−T₁) and Y₂=Y₁+(Y₃−Y₁)*(T₂−T₁)/(T₃−T₁).

More generally, the value of any quantity Q at time t can be interpolated from neighboring table entries (time1, Q1) and (time2, Q2), where t=time1+delta_t, as Q(t)=Q1+(delta_t/(time2−time1))*(Q2−Q1).

Content acquired off-the-path can even be placed on the map according to its known location. For example, an image of a landmark such as San Francisco's Golden Gate Bridge can readily be placed atop the bridge's location on the map.

Having placed the traversed path on the map, and the content on the map, the user can look down at the displayed map from above, and re-create the trip (in whole or in part), either by moving a pointer (e.g., a cursor) to a desired vantage point and viewing the path and content therefrom, or by “flying” the path and viewing content as it is encountered from a moving vantage point.

Various embodiments of this technology are described in detail in a variety of co-pending patent applications (the “Pending Applications”), all of which are hereby incorporated by reference in their entirety.

The first such patent application, U.S. Ser. No. 10/427,614 filed on Apr. 30, 2003, is entitled “Apparatus and Method for Recording ‘Path-Enhanced’ Multimedia,” and describes a device for creating a digital file representing the path and the content-bearing media, that is usable for playback (the so-called “Path-Enhanced Multimedia”). The file includes a plurality of segment records and media records. Each segment represents some portion of the traversed path, and includes at least one geotemporal anchor. Each anchor includes an associated time and, optionally, an associated location. The anchors collectively define a specified path (in space) traversed over a specified period (in time) via fields for time, location, and 30 other optional parameters. At least some of the anchors are linked to respective instances of the recorded media.

The second such patent application, U.S. Ser. No. 10/427,582 filed on Apr. 30, 2003, is entitled “Automatic Generation of Presentations from ‘Path-Enhanced’ Multimedia,” and describes various playback processes related to rendering the path and the associated content-bearing media viewable from or along the path. The presentation thus generated would typically include multiple recorded events, together with an animated path-oriented overview connecting those events.

The third such patent application, U.S. Ser. No. 10/427,649 filed on Apr. 30, 2003, is entitled “Systems and Methods of Viewing, Modifying, and Interacting with ‘Path-Enhanced’ Multimedia,” and describes a software application for providing different views of the file. More specifically, this application includes techniques for exploring, enhancing, and editing the content-bearing media, and for editing a path to define a new or modified path. The views may be selected based on geography, image type and/or time considerations.

The fourth such patent application, U.S. Ser. No. 10/427,647 filed on Apr. 30, 2003, is entitled “Indexed Database Structures and Methods for Searching Path-Enhanced Multimedia,” and describes database structures and data searching procedures for recorded content having associated times and locations. More specifically, this application pertains to techniques for indexing, modifying, and searching data structures including a linked sequence of path segments.

The present application builds on and extends the Pending Applications by describing various additional trip recording and simulation techniques, related primarily to enhanced three-dimensional functionality.

III. Enabling a Three-Dimensional Simulation Through a Region

A. Acquiring Location Information as a Function of Time

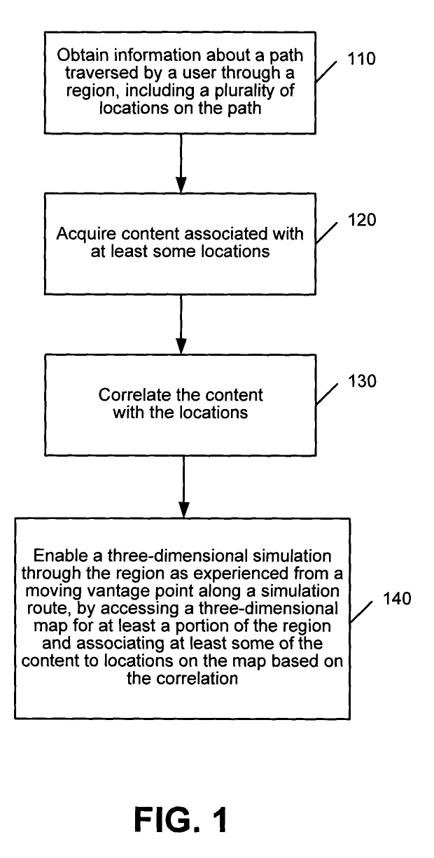

Referring to FIG. 1, at step 110, as a visitor makes a trip through a region, information is recorded about a path traversed by the visitor. In an exemplary embodiment, the information is captured as a series of location coordinates as a function of time. For example, GPS technology could be used to take measurements once a second, with each measurement including a latitude, longitude and elevation (or altitude). The latitude and longitude may be regarded as two-dimensional coordinates (depicting location on or parallel to the surface of the earth), while the elevation may be regarded as a third coordinate (depicting height, usually relative to the surface of the earth). GPS technology is well-known to those skilled in the art, and GPS receivers are widely commercially available (e.g., from Trimble Navigation, Garnin, and others), so these aspects need not be described in greater detail herein.

Of course, any other alternative location measurement technology can also be used in place of, or as a supplement to, GPS. For example, these might include other satellite-based signals (such as GLONASS or GALILEO), inertial navigation systems, LORAN, laser range finding, and still other technologies known to those skilled in the arts of surveying, navigation, and/or reckoning.

B. Acquiring Orientation Information (Optional)

For some applications, it may be desirable to capture orientation information, in addition to just location information. The orientation information would indicate the direction in which the user was oriented (e.g., facing) at the time he/she was at a particular location. Orientation information can be captured using digital compasses, such as those built into many commercially available GPS receivers.

C. Content Acquisition

Referring again to FIG. 1, at step 120, content associated with at least some of the locations is acquired. The content may be of any type that is digitally representable or otherwise computer-readable. For example, media such as photos, videos, and/or audio recordings may be used to capture sights and sounds along the traversed path. Alternatively, representations of sights or sounds associated with the locations, even if not actually captured by the user, may also be added. For example, these might include graphics, logos, icons, man-made images, advertising, and any other type of synthetic content which can be digitally represented. Some exemplary synthetic content might include representations of physical data (e.g., a snowflake graphic associated with a freezing cold day), a material property (e.g., particularly for scientific applications), digital text (e.g., the text of an inauguration speech associated with a White House visit), computer-synthesized data (e.g., a space shuttle simulation to be associated with a NASA visit), and so forth.

The content associated with a location can occur at the path location (e.g., a photo taken of the user standing on the path), occur near the location (e.g., where the user photographs a building from a footpath surrounding it), or even represent a distant object as seen from the path (e.g., where the user photographs a fireworks display from a safe distance away).

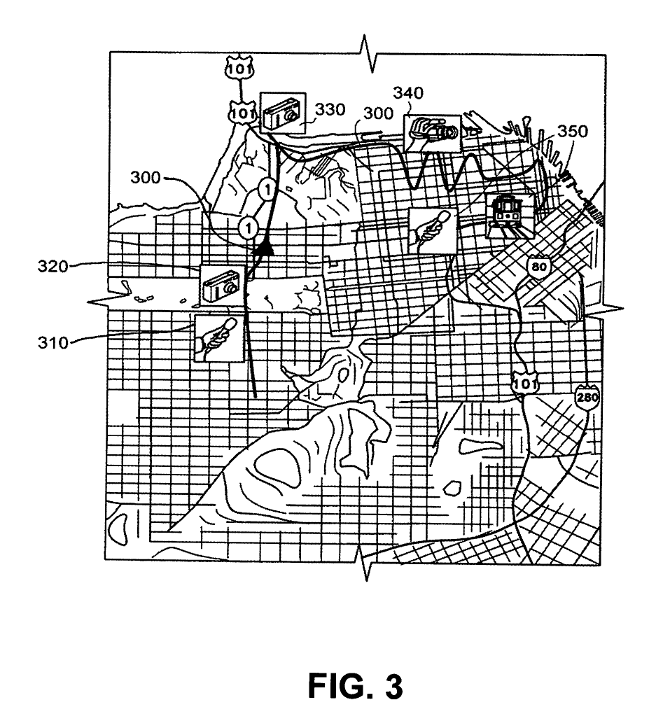

The acquisition of content is depicted schematically in FIG. 3, which illustrates an exemplary path 300 traversed by a visitor through the city of San Francisco. In this exemplary embodiment, the user's GPS receiver continuously samples (time, location) data, at sufficiently close intervals, to form a reasonably accurate record of the entire path traversed.

As the visitor traverses the path, the visitor also acquires any desired content. In the exemplary trip of FIG. 3, at location 310, after beginning to acquire GPS location signals (i.e., just beyond the beginning of the path), the visitor records a sound clip (e.g., “I'm starting my city tour now”) as schematically indicated by a microphone icon. The current time is either captured by a clock in the recording device (e.g., a camcorder), or recorded by the user himself (e.g., “It's 2:15 pm and I'm starting my city tour now”). At locations 320 and 330, the visitor takes digital photos (or still photos that are later scanned to produce digital photos), as schematically indicated by a camera icon. At location 340, the visitor shoots video footage, as schematically indicated by a camcorder icon. The user's digital camera and camcorder include a timestamping capability, so that the times at which the images were recorded are also captured. These times will subsequently be used to correlate the content with its location on the path, as will be described in Section III.E below.

In some cases, the acquired content may not have a timestamp, in which case the visitor may record it separately. For example, at location 350, the visitor boards a sightseeing trolley and purchases a souvenir trolley keychain. The user can take a digital photo of the keychain, for subsequent insertion into the trip record. The visitor can also record an audio commentary when the souvenir was purchased, as schematically indicated by the microphone icon, for use along with the photo, in the trip record.

D. Content-Path Correlation

Referring again to FIG. 1, at step 130, the content is correlated with the path. If the time at which a location data point was acquired exactly matches the time at which a content item was acquired, then the location of the content is immediately known. In general, however, this may not be the case. Rather, the content is likely to have been acquired between a pair of successive (time, location) measurements. In that case, the content location (latitude, longitude, elevation) can simply be interpolated from the nearest (time, location) measurements, using the techniques disclosed in Section II above, or in the Pending Applications, or still other interpolation techniques known to those skilled in the art. Since the interpolation is time-based, accurate interpolation depends on proper synchronization between the GPS device's clock and the clock used to timestamp the content. If necessary, such synchronization can be performed prior to beginning the trip. Alternatively, if the offset between the two times is known, it can be applied as a correction factor prior to interpolation.

In an exemplary implementation, an electronic file is written containing the path locations, the content locations, and the content items (or references thereto). The file can take any desired format, according to the needs of a particular implementation. For example, if it is desired to maintain compatibility with the file structures used in the Pending Applications, the so-called “Path-Enhanced Multimedia” or “PEM” files disclosed therein could readily be used.

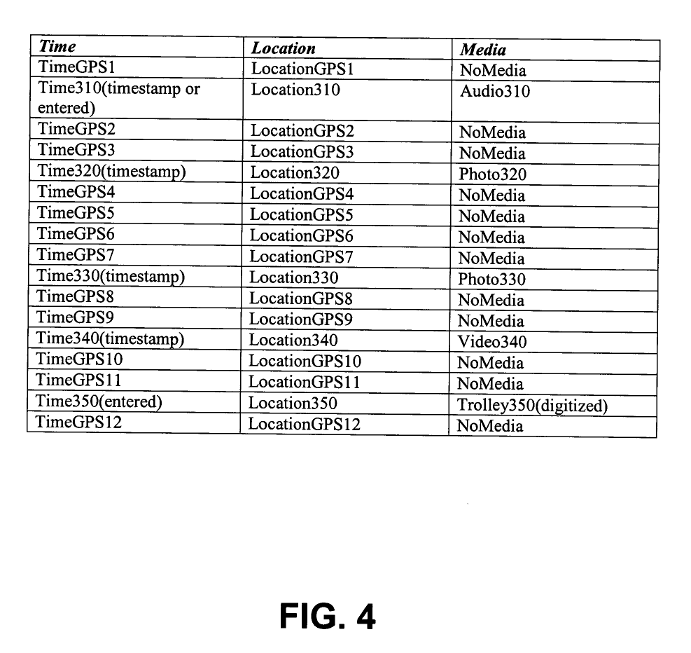

More generally, the file might be as simple as that schematically depicted in FIG. 4, which includes a series of (time, location, media) entries. The location entry refers to either a path location (acquired from GPS or other suitable techniques), or a content location. The media entry refers to either a pointer to a content-bearing medium (for a content location), or a null pointer (for a pure path location). The time entry refers to the time associated with the location or content.

For illustrative purposes, the exemplary (time, location, media) data in FIG. 4 are keyed to the exemplary content of FIG. 3. The path is defined by GPS signals acquired at time sequences TimeGPSn (where n varies from 1 through 12). Each TimeGPSn has an associated location measurement LocationGPSn. Because (at least in this example) there is no content exactly corresponding with any GPS signal, each GPS entry also has a NoMedia reference.

The other (time, location, media) entries in the file indicate content capture points from FIG. 3. The first entry, for a sound recording, includes a Time310 originating either from an automatic timestamp, or captured in and entered from the visitor's audio recording. This entry also includes a Location310 interpolated from the surrounding GPS entries (LocationGPS1 and LocationGPS2), and a reference to sound recording Audio310. In a similar manner, the photo (320, 330) and video (340) content entries include their respective timestamps, interpolated locations, and content data. The last content entry, corresponding to the visitor's trolley tour, includes a Time350 (entered from the sound recording described with respect to FIG. 3), a Location350 (interpolated from GPS11 and GPS12), and a reference to a digitized image of the trolley keychain (Trolley350).

In some applications, it may be beneficial for the content items to be organized and stored according to predetermined classifications. As just one example, content items could be flagged as either “nature” or “historical,” in order to facilitate the selective or differential displays for “nature lovers” or “history buffs” during subsequent simulations.

Additionally, if orientation information is available (see Section III.B), it can be recorded in an orientation field. For example, the exemplary entries of FIG. 4 might be modified to the following format: (time, location, orientation, media). An exemplary orientation field might, in turn, take the form orientation=(wx, wy, wz, theta), where (wx, wy,wz) represents an axis of rotation (i.e., a vector in three-dimensional space) and theta is the amount of rotation about that axis. Other ways to specify a rotation/orientation include euler angles, quaternions, roll-pitch-yaw, and/or still other techniques known in the art.

E. Enabling a Three-Dimensional Simulation

Finally, at step 140, a three-dimensional simulation through a region is enabled by: (1) accessing a three-dimensional map for at least a portion of the region; and (2) associating at least some of the content to locations on the map based on the correlation (of step 130).

1. Accessing a Three-Dimensional Map

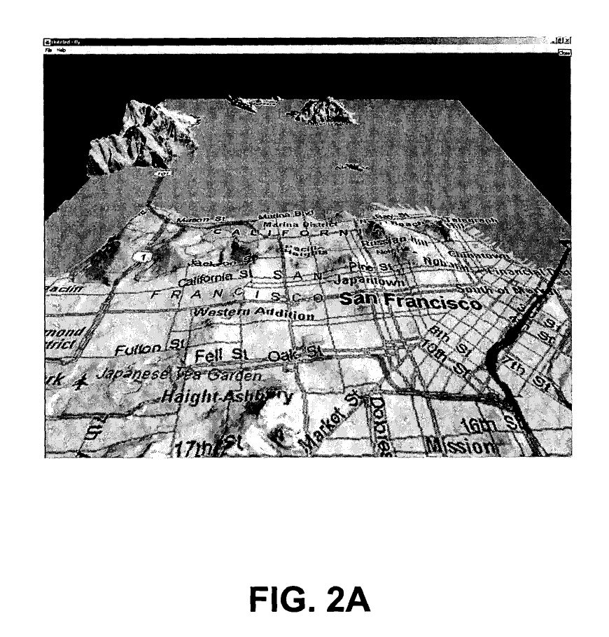

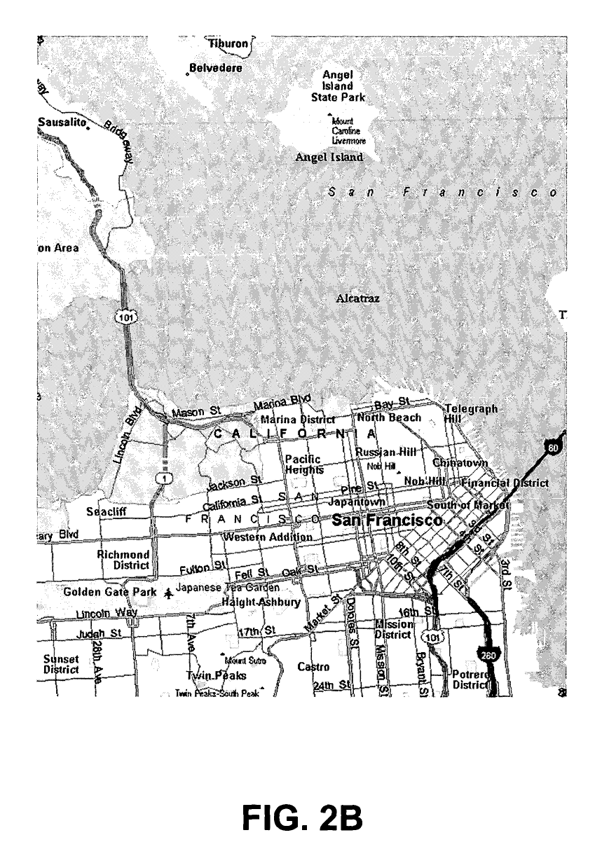

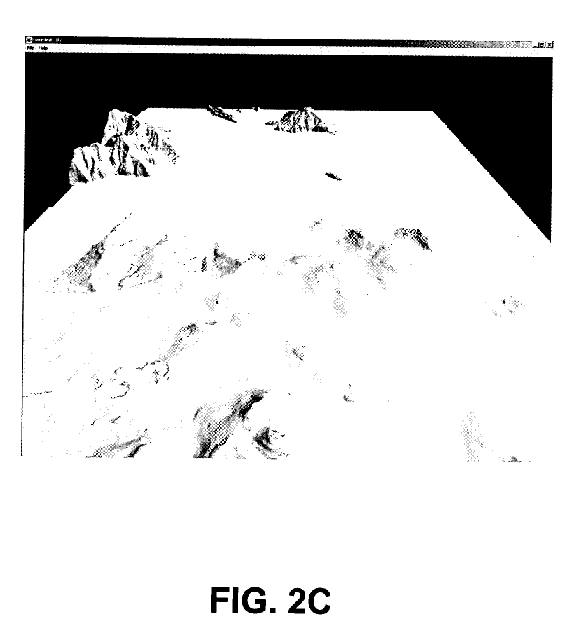

FIG. 2A illustrates an exemplary three-dimensional map of a region through which the trip is taken. This exemplary map depicts the city of San Francisco, Calif., and includes three-dimensional information such as hills in the city itself as well as islands in San Francisco Bay. This exemplary map also depicts man-made landmarks such as city districts (e.g., the “Western Addition” near the center of the map), city streets (e.g., “California St.” just north of the Western Addition), and freeways (e.g., Highway 1 near the left edge of the map).

The exemplary map of FIG. 2A could have been created by texture mapping the exemplary two-dimensional digital street map shown in FIG. 2B onto the exemplary three-dimensional digital topographic map shown in FIG. 2C. Street maps are readily available from commercial sources (see, for example, http://www.mapqguest.com), and topographic maps are readily available from sources such as the United States Geologic Survey (see, for example, http://rockvweb.cr.usgs.gov/elevation/dpi_dem.html). Texture mapping is a well-known technique for rendering a two-dimensional surface pattern onto an underlying three-dimensional object, and need not be described in detail herein. For example, see Alan Watt & Mark Watt, “Advanced Animation and Rendering Techniques: Theory and Practice,” ACM Press and Addison Wesley, ISBN 0-201-54412-1 (1992) and Paul S. Heckbert, “Survey of Texture Mapping,” IEEE Computer Graphics and Applications, pp. 56-67 (November 1986).

Since the map is to be used to record path locations, the map coordinate and location coordinate formats should either be the same, or mathematically convertible from one to another (i.e., registerable to common coordinates).

The exemplary digital elevation map of FIG. 2A is just one of many possible three-dimensional maps of a region that could be used in connection with the recording and simulation (see Section IV) technologies disclosed herein. In general, any form of three-dimensional map could be used to depict any exterior and/or interior region. For example and without limitation, other exemplary exterior maps might include topological maps (e.g., showing hiking trails), subsea maps (e.g., for oil drilling or undersea navigation), and maps including man-made features (e.g., buildings and other landmarks). Similarly, some exemplary interior maps might include maps depicting building interiors (e.g., a factory layout), utility duct layouts (e.g., for wiring installation and repair applications), and even the human body (e.g., for laparoscopic diagnosis or surgery using a remotely controlled probe).

2. Associating Content with Locations on the Map

At least some of the content is associated with locations on the map based on the correlation between acquired content and at least some of the locations recorded along the traversed path (see step 130). In an exemplary implementation, data in an electronic file (see FIG. 4) may be used to associate contents with locations on the map. For example, the location data (e.g., GPS data) in the electronic file may be used to determine the appropriate areas on the three-dimensional map where certain acquired content is to be presented (e.g., display an image, play an audio recording, etc.). At this point, a three-dimensional simulation through the region traversed by the user is enabled and will be described in more detail below.

IV. Presenting A Three-Dimensional Simulation Through a Region from a Moving Vantage Point

The information captured by the visitor in Section III can be used for subsequent interactive or automated (or a combination thereof) simulation of a trip through a region from a moving vantage point. More particularly, the traversed path and content are displaced upon a three-dimensional map (e.g., the map accessed at step 140 in FIG. 1), to enable the user to interactively simulate a desired simulation route to experience content as it is encountered from a moving vantage point.

Some aspects of the interactive simulation can be automated, allowing the user to benefit from computer implementation of complex tasks (for example, and without limitation, collision-avoidance and terrain-based navigation) while still retaining interactive control of the overall experience. A three-dimensional simulation can also be completely automated, whether on the traversed path or a simulated route. For ease of explanation, and without limitation, the “traversed path” refers to the path traversed by the visitor through a region during recording of content and locations and the “simulation route” refers to the three-dimensional simulation route through a region that does not necessarily have to be the same route (although it can be the same) as the traversed path.

A method of using the correlation between the acquired content and locations (i.e., created at step 140 of FIG. 1) to enable a three-dimensional simulation is described in greater detail below, beginning with an initial step of accessing information about a traversed path, including a plurality of locations along the path. In an exemplary implementation, this information is located in an electronic file stored on a computer system.

A. Initialization

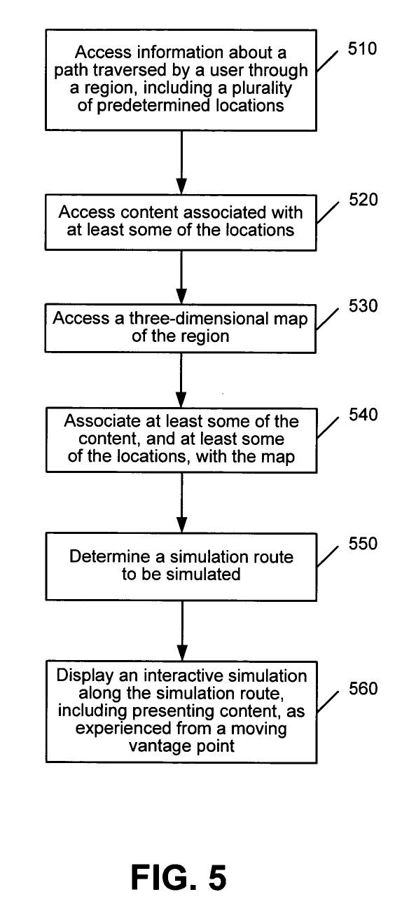

Referring now to FIG. 5, at step 510, information about a traversed path through a region, including a plurality of predetermined locations, is accessed. If orientation information was recorded, it can also be accessed as desired. At step 520, content (whether previously captured and/or synthesized) associated with at least some of the locations is accessed. At step 530, a three-dimensional map of the region is accessed, and at step 540, at least some of the content and locations are associated to corresponding areas on the map. At this point, the map has been initialized and is ready to be used for simulation.

B. Simulation

1. Introduction

At step 550, a simulation route in the three-dimensional map is determined. As a matter of convenience, the simulation of the simulation route may also be referred to as a flyby. The simulation route comprises a succession of vantage points. During simulation, at step 560, the user is presented with the experience of flying from one vantage point to another along the simulation route. Or, stated another way, the vantage points move over time to trace out the simulation route. During a simulation, in an exemplary implementation, the user may also move the vantage point off the simulation route as desired, for example, by clicking on an area of the map not along the simulation route.

The vantage points along the simulation route can occur at any altitude (or succession of altitudes) and/or orientation with respect to the three-dimensional map, whether at “ground” level or “sky” level, or otherwise. Indeed, in applications such as those representing a diving excursion, a tunneling operation, or a mining operation, the flying can even occur in a subsurface fashion (e.g., underwater or underground).

2. User Interfaces

The user can specify and control the simulation (at step 550) using any appropriate form of user interface. For instance, a user interface can be employed to specify and/or control the simulation route. In one exemplary implementation, if the simulation is implemented in software designed to run on standard personal computers, the interface could include selection boxes displayed in a window and controlled using a mouse or keyboard. Or, if the simulation is implemented as software running on a computer having more sophisticated control equipment, or even implemented in hardware devices, the interface could include rolling balls, joysticks, keyboard, mouse, and other mechanisms (e.g., pen and display surface for a tablet PC) that are particularly well-suited to three-dimensional control.

3. Interactive Simulation

The user's ability to control the simulation route allows the user to interactively control the simulation in real time. In one exemplary embodiment, the user uses a mouse, keyboard, or joystick to trace out the desired simulation route, i.e., a succession of moving vantage points, in real time. The moving vantage points need not necessarily be continuous along the simulation route during a simulation. For example, during a simulation, the user may move the vantage point off the simulation route as desired by clicking on an area of the three-dimensional map that is off the simulation route. The simulation route may be specified beforehand and/or altered dynamically during the simulation itself. The system simulates and displays to the user what he/she would see (and/or otherwise experience) as he/she traverses the simulation route from the perspective of the moving vantage point.

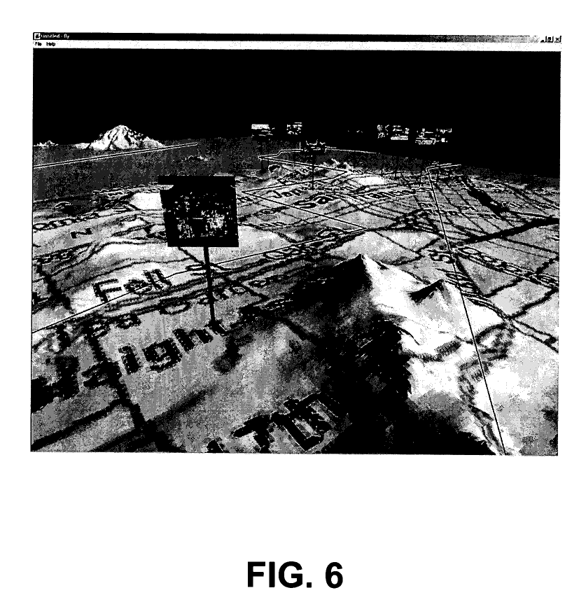

During a simulation, the user may have the experience of “flying” along a simulation route on the displayed three-dimensional map while various content along that route are presented to the user. For example, with respect to the exemplary three-dimensional map of FIG. 2A, an exemplary simulation might appear as shown in FIG. 6, which depicts one particular part of the simulation. (FIG. 6 also includes the use of rotating billboards to depict content, as will be described in greater detail in Section IV.D below.)

4. Obtaining Information

Another exemplary aspect of interactive simulation might allow the user to obtain more information about the three-dimensional map, the simulation route, and/or the content by clicking on or otherwise selecting, or even by simply approaching areas on the displayed simulation. For example, more information (e.g., zooming in for more detail, obtaining hours of operation or admission fee information from an embedded hyperlink to the content's web site, etc.) could be obtained about a particular content item seen from the simulation route by clicking, selecting, or approaching the content item. Of course, such information is not restricted to content items alone. For example, a surveying application might be configured with a special display window that continuously displays the elevation along the simulation route, a driving application might include a simulated speedometer, etc.

5. Variable Orientation and Field-of-View

In one exemplary implementation, the user might traverse the simulation route in a facing-forward manner. This is analogous to driving a car and looking straight ahead. While the travel experience thus presented might be somewhat limited, this type of simulation has the advantage of requiring relatively straightforward inputs from the user (e.g., translational but not rotational motions) that may be more readily accommodated by inexperienced users and/or with simple user interfaces.

A more sophisticated form of simulation can readily accommodate changes in user orientation along the simulation route. By analogy, if the user were flying in an airplane, the user could also control the roll (e.g., leaning left or right), pitch (e.g., leaning forward or backward), and yaw (e.g., swiveling from side to side) of the aircraft while the user flies along the simulation route. In a computer simulation, this might be conveniently implemented using a joystick as the user interface.

As the orientation changes, the field-of-view will also change. Techniques for calculating the particular field-of-view to be displayed at any instant during the simulation are described in Section IV.C below.

6. Automated Assistance

The three-dimensionality of the simulation route allows a virtually unlimited richness of simulation. However, the limitations of available user interfaces, and/or difficulties associated with specifying three-dimensional routing parameters in a two-dimensional computer display, may make it difficult or inconvenient for users to easily control the simulation. To assist with such situations, the user's interactive capabilities can be augmented with automated processing capabilities that can be used in conjunction with, and as part of, the overall interactive simulation experience.

As one example, a user might wish to interactively replay a traversed path. In this case, an automatic replay capability could simply force the desired simulation route to follow the traversed path and orientation information. Of course, information associated with the traversed path may not exactly match the desired framing intervals, or the playback simulation's framing rate may exceed the recording rate (i.e., the recorded data are sparse compared to the desired simulation data). In those cases, any desired simulation data point (location and/or orientation) may simply be interpolated from the nearest neighboring data points using the techniques set forth in Sections II and III.E above.

This kind of automated playback liberates the user from the drudgery of manually recreating (e.g., by manually selecting points along the simulation route) a simulation route that is already known to the computer system, while still allowing the user to interactively control the simulation experience through such features as pausing to visit a landmark (e.g., by clicking on it), speeding through some portions of the simulation (e.g., by dragging a progress indicator to speed up the simulation), skipping some portions of the simulation (e.g., by repositioning a progress indicator), taking a detour off the simulation route (e.g., by pulling or pushing on a “handle” on the default traversed path, similar to the way one changes the shape of a curve in a computerized drawing program), and still other forms of manually overriding the automatic simulation.

That is, the system can automatically determine a simulation route related to, but not necessarily the same as, the traversed path. This falls between the extremes of experiencing the traversed path (on the one hand) and conducting a totally interactive simulation (on the other hand). For example, referring back to the San Francisco trip depicted in FIGS. 2, 3 and/or 6, during one exemplary type of automatic playback simulation, the system could start the user at a high elevation looking down on the map of the city, then swoop into the city and follow the simulation route at eye level. Of course, the user can break out of this automatic playback mode at any time and return to interactively controlling his/her vantage point.

As one example, a user on a sightseeing simulation might care to visit a series of city landmarks, but be indifferent as to the portions of the simulation route between the landmarks. In that case, the user could interactively select (using a mouse, etc.) the desired sequence of locations, and a curve-fitting algorithm could automatically determine the simulation route using well-known curve fitting techniques (e.g., polynomial least squares fitting, splines, etc.). The simulation can then fly the simulation route without requiring further input from the user.

As another example, other automated processing capability might include terrain-based processing (e.g., a tour of all San Francisco city hills above 200 feet in elevation, a simulated helicopter tour at 10,000 feet above local ground level, etc.). In such cases, the user would interactively input some overall parameter (e.g., the 200-foot hill threshold or the 10,000-foot flight altitude), and the program would automatically calculate and/or adjust the simulation route to accommodate the user's wishes.

C. Field-of-View Considerations

The perspective and size of the displayed map are related to the particular field-of-view which is simulated. In general, the field-of-view can reflect one or more user-specifiable parameters. For example, a desired simulation location/orientation could be specified (e.g., an overhead or birds' eye view, a southerly view, etc.). Or, a desired viewing angle could be specified (e.g., wide angle, narrow angle, etc.) Or, a desired viewing area could be specified (e.g., three blocks square, a rectangle 1 mile wide by 2 miles long, etc.).

In a simulation application, the field-of-view problem is: given a desired three-dimensional vantage point (simulating a position of an observer), viewing orientation, and viewing angle or size, how does one calculate the portion of a three-dimensional region that should be displayed to the user at each instant during flyby?

1. Viewing the Traversed Path from an Off-Path Simulation Route

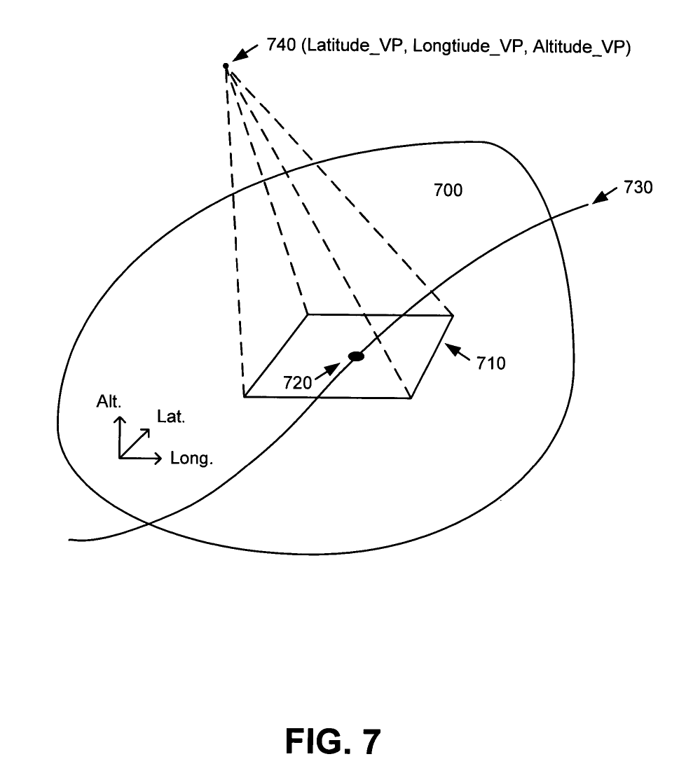

FIG. 7 illustrates one exemplary technique for calculating a portion 710 of the region 700 to be displayed during simulation. Portion 710 is instantaneously centered about location 720 on the traversed path 730. This illustrates the exemplary case of a user viewing a portion of the traversed path 730 from a point 740 on the simulation route. (To avoid cluttering the figure, the simulation route is not shown in FIG. 7.).

The user specifies the desired size of portion 710, perhaps by entering its coordinates, by clicking to select its corners, or otherwise. In an exemplary embodiment, the portion 710 has the same aspect ratio as, and is mapped to, a corresponding display window on a display monitor. The specified vantage point 740 is connected to the portion 710 (see the dashed lines) to form a pyramidal volume. Those portions of the map or content falling inside the pyramidal volume are displayed, while those outside the pyramidal volume are not. As an alternative to directly specifying the size of portion 710, it could be calculated from the user's specification of the desired viewing angle(s) (e.g., the angular spread of the pyramidal volume).

2. Viewing Along an Arbitrary Direction

The foregoing example illustrates viewing a portion of the traversed path 730 from a vantage point 740 on the simulation route. That is, the simulation route is off of the traversed path, but with a view oriented toward the traversed path. In general, however, the user's orientation could be in an arbitrary direction.

The exemplary technique of FIG. 7 can readily be adapted to this more general case. Again, a pyramidal volume is drawn from the instantaneous vantage point along the desired orientation. In an exemplary embodiment, the pyramid is then mathematically filled in by “shooting” a plurality of equally spaced rays, originating from the vantage point, within the pyramidal volume. Each ray is continued until it intersects an object (e.g., terrain, building, etc.), the corresponding data (from the 3-D map and content) are drawn in at the point of intersection. Any additional data beyond the point of intersection would be hidden, and thus, not displayed.

3. Automatic Playback of a Traversed Path

Automatic playback of a traversed path represents an instance where the simulation route simply follows the traversed path. This can be visualized by inverting the pyramidal volume of FIG. 7, so that at any given instant, vantage point 740 coincides with location 720.

The instantaneous viewing orientation could be given by the orientation parameters, if any, that were previously recorded (see Section III.B). Or, if there is no recorded orientation, it might be assumed that the user is looking “straight ahead” (in which case the orientation would be tangent to the instantaneous position on the traversed path). Or, the user could follow the simulation route but be looking around in a user-specified fashion (e.g., simulating a child staring out a rear window of a car). Thus, in the most general case, any arbitrary orientation could be simulated as a function of time.

Whatever the orientation, the technique for calculating the field of view at any instant of time remains conceptually similar to that given above: (1) draw a pyramidal volume which has an apex originating at the vantage point, which is spatially centered about the desired orientation, and which has a breadth equal to the desired viewing angle or area; (2) shoot rays originating at the vantage point through the interior of the volume until the rays intersect an object; and (3) display the portion of the object at the point of intersection.

D. Rotating Billboards and Other Off-Path Display of Content

In a simulation where the simulation route is the traversed path, because the traversed path is simply retraced (in part or in whole), the content will be played back from the same perspective at which it was acquired. In other forms of simulation, the perspective of the recorded content may differ significantly from that of the simulation perspective(s). For example, the user may have photographed the front of a building, while the simulation route lies behind the building. Or, the recording perspective could be at ground level, while the simulation perspective is from an airplane.

To accommodate possible variations in recorded versus simulated vantage points, the content can optionally be displayed as a series of rotating billboards (as seen in FIG. 6) projecting upward over the corresponding locations on the displayed map.

In an exemplary embodiment, the billboards rotate as the user traverses the simulation route, so that the billboards always remain pointed toward the user. In this way, the billboards maximize their visibility. In particular, suppose the user's instantaneous vantage point as defined in the three-dimensional graphics world is given by

(x_user{t}, y_user{t}, z_user{t})

and a billboard is located at a fixed location given by

(x_billboard, y_billboard, z_billboard).

Then, the billboard is rotated so that its visible face points in the direction of the vector

(x_user{t}-x_billboard, y_user{t}-y_billboard, z_user{t}-z_billboard).

Optionally, to avoid complications such as tilting, the billboards could be implemented to rotate only in the 2D (i.e., x-y) plane.

With the use of billboards, the content is located at the proper two-dimensional location on the path, but with a vertical offset. The vertical offset is a form of off-path content display, and may be particularly useful where the content would otherwise cause unacceptable visual blockage of the simulation route (or other parts of the map) and/or where the content is in a larger size than would otherwise be possible to display. In other situations, it may be desirable to have content placed horizontally off-path. More generally, any form of off-path display of content can be used (or not used) according to the particular needs of a specific implementation.

Depending on the desired implementation, the billboards (or other form of off-path display) can be “always on” or activated as needed. For example, billboards that would be too small to see, from an instantaneous path location and associated field-of-view, could be hidden entirely or displayed statically (e.g., without rotation). Then, as the user approached to within a threshold distance from the billboard, it could become visible or be displayed dynamically (e.g., with rotation).

E. Avoiding Collisions

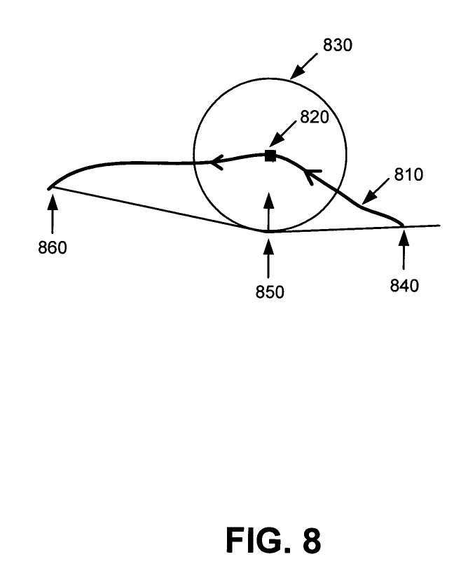

When the displayed content has a finite dimension (whether horizontal or vertical), it is possible that the user might fly into, or otherwise collide with, the content during simulation. FIG. 8 schematically illustrates a technique for addressing the collision-with-content problem. The curved line 810 indicates a simulation route, and the small square 820 depicts content potentially subject to collision. For convenience, the content is drawn as being centered on the route. However, it should be understood that this is not necessarily the case. For example, the content could be centered to the left or right of the route, yet be so wide that a portion of it would be subject to collision when traveling the simulation route.

An exemplary collision-avoidance protocol involves altering the route by a distance R sufficient to avoid collision. The distance depends on the size and location with which the content is displayed during simulation (which may or may not be the same as the true size of the content). A circle 830 of radius R, centered on the intersection of the content with the route, indicates a locus of points usable for implementing an alternate route. This alternate route has two segments, a first segment starting from a point of departure 840 tangent to the initial route and intersecting the circle at point 850, and a second segment that rejoins the initial route at point 860. Departure and reconnection points 840 and 860 are selected so that the angle between the original route and the modified route, where the two routes meet, is not too sharp. During trip replay, this allows for smooth transition from the original to the modified route and back again.

The inward-pointing arrow at point 850 indicates an exemplary orientation of the view displayed to the user during that point of the collision-avoidance protocol. Once the alternate route is known, the view orientation can even be automatically adjusted to keep the content in sight at all times.

It may be desirable to give the user a slight pause at some point in the simulation, in order to allow more time to view the content. Such a pause can be implemented by repeating the instantaneous location and media entries nearest to the point of closest approach (850) over the desired time interval. For example, referring back to the exemplary file of FIG. 4, display of the trolley image could be extended for a 5-second interval by replacing the existing entry, (Time350, Location350, Trolley 350), with a series of entries such as:

(Time350, Location350, Trolley350)

(Time350+5 sec, Location350, Trolley350).

In the foregoing example, one image was replaced with two. More generally, the application's rendering engine can determine how many images are required based on the desired frame rate.

In order to prevent time conflicts with the subsequent entries, it may be appropriate to adjust their times accordingly. For example, the last entry in FIG. 4, (TimeGPS12, Location12, NoMedia) might be adjusted to (TimeGPS12+5 sec, Location12, NoMedia).

V. Alternative Embodiments and Aspects

A. Simulated Trips

In the foregoing examples, the exemplary trip being recorded was a trip actually taken by a user (e.g., through a city region). However, the techniques disclosed herein are not necessarily restricted to actual trips. For example, a user who is familiar with a city, its landmarks, and travel times along given city streets, could create a facsimile of an actual trip by recording a synthesized travel route and inserting the appropriate content along the route at the proper locations and times. Depending on the circumstances, the synthesized travel route through a region might be more useful or informative than recording a trip actually taken by a user.

B. Mixing and Merging of Trips and Simulations

A high degree of interactivity can be provided by allowing the mixing and/or merging of different trips and/or simulations. For example, a plurality of trips could be integrated onto the same 3-D map. The trips can come from the same individual captured at different times, or from multiple individuals.

Similarly, a simulation could be displayed to multiple users capable of simultaneously viewing it. The users could be at the same computer (e.g., one having multiple user interfaces), or on different computers (e.g., linked by a computer network). Each user could have his/her own independently controlled vantage point, or the users could each be capable of moving the same vantage point.

If desired, each user could be depicted using a photo, avatar, or some other unique representation. This would allow the users to see one another in the 3-D environment, thereby facilitating interactive communication and sharing of details about the trip(s).

C. Different Ordering of Steps

Also, the various techniques disclosed herein have been presented using an exemplary ordering of steps. However, the techniques should not be understood as restricted to those orderings, unless strictly required by the context. For example, in FIG. 1, the map accessing step (140) could occur at any place in the overall sequence, rather than as the last step. Similarly, in FIG. 5, the map accessing step (530) could occur at any place in the sequence prior to those steps involving placing data on the map.

VI. Exemplary Applications

In the foregoing, a sightseeing trip has been used as an exemplary application for trip recording and simulation. However, the technologies disclosed herein are also widely applicable to many other consumer and business uses. For example, trip recording would be useful for real-estate agents building map-based multimedia presentations of homes for sale; and the corresponding trip simulation would be useful for potential home buyers as a substitute for, or as a supplement to, live property tours. The technologies would also be useful for recording and reviewing archaeological digs, crime scenes, military reconnaissance, surveying, and any other application where it is beneficial to have a spatially and temporally accurate log of locations visited, and content experienced, while traversing a region of interest.

VII. Exemplary Computer Environments

In an exemplary implementation, the techniques described herein can be implemented using any suitable computing environment. The computing environment could take the form of software-based logic instructions stored in one or more computer-readable memories and executed using a computer processor. Alternatively, some or all of the techniques could be implemented in hardware, perhaps even eliminating the need for a separate processor, if the hardware modules contain the requisite processor functionality. The hardware modules could comprise PLAs, PALs, ASICs, and still other devices for implementing logic instructions known to those skilled in the art or hereafter developed.

In general, then, the computing environment with which the techniques can be implemented should be understood to include any circuitry, program, code, routine, object, component, data structure, and so forth, that implements the specified functionality, whether in hardware, software, or a combination thereof. The software and/or hardware would typically reside on or constitute some type of computer-readable media which can store data and logic instructions that are accessible by the computer or the processing logic. Such media might include, without limitation, hard disks, floppy disks, magnetic cassettes, flash memory cards, digital video disks, removable cartridges, random access memories (RAMs), read only memories (ROMs), and/or still other electronic, magnetic and/or optical media known to those skilled in the art or hereafter developed.

VI. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims. Furthermore, some of the claims may include alphanumeric identifiers to distinguish the elements thereof. Such identifiers are merely provided for convenience in reading, and should not necessarily be construed as requiring or implying a particular order of steps, or a particular sequential relationship among the claim elements.

What is claimed is:

1. A method for enabling a three-dimensional simulation through a region, comprising:
obtaining information about a path traversed by a user through a region, including a plurality of locations on said path;
acquiring content associated with at least some of said locations;
correlating said locations with said content; and
enabling an interactive three-dimensional simulation through said region as experienced from a moving vantage point along a simulation route, including:
accessing a three-dimensional map for at least a portion of said region; and
associating said acquired content to locations on said three-dimensional map based on said correlation.

2. The method of claim 1 where said simulation route is different than said traversed path.

3. The method of claim 1 where said simulation route is at least partially user-specifiable.

4. The method of claim 1 where said simulation route is at least partially automatically generated.

5. The method of claim 1 where:
(i) at least some of said locations are known as a function of time;
(ii) at least some of said content is identifiable by its time of acquisition; and
(iii) said associating includes using said times in (i) and (ii) to determine locations on said map where said content should be associated.

6. The method of claim 1 where said content represents synthetic content.

7. The method of claim 1 further comprising organizing said content in an electronic file by classifications thereof.

8. The method of claim 1 where said obtaining information about said path includes capturing orientation information along said traversed path.

9. A method for simulating a trip through a region, from a three-dimensional vantage point, comprising:
accessing information about a path traversed through a region, including a plurality of predetermined locations;
accessing content associated with at least some of said locations;
accessing a three-dimensional map of said region;
associating at least some of said content, and at least some of said locations, with said map;
determining a simulation route through said region; and
displaying to a user an interactive simulation along said simulation route, including presenting content along said simulation route, as experienced from a moving vantage point.

10. The method of claim 9 further comprising presenting at least some of said content at least partially off of said path.

11. The method of claim 10 further comprising displaying at least some of said content as a rotating image.

12. The method of claim 10 further comprising suspending presentation of said off-path content based on its proximity and field-of-view relative to said user.

13. The method of claim 9 where:
(i) said simulation route substantially tracks said traversed path; and
(ii) said moving vantage point follows said traversed path.

14. The method of claim 9 including modifying at least a portion of said simulation route to avoid collision with at least some of said content during said simulation.

15. The method of claim 9 including specifying at least a portion of said simulation route in accordance with local terrain features.

16. The method of claim 9 further comprising presenting more detailed information about at least one item of content selected by said user.

17. The method of claim 9 further comprising defining said moving vantage point by said user's selection of at least one item of content.

18. The method of claim 9 further comprising pausing, while presenting at least some of said content, to improve user access thereto.

19. The method of claim 9 further comprising executing at least one automated process for performing a user-specified interactive simulation aspect that would otherwise be inconvenient for the user to implement manually.

20. The method of claim 19 further comprising accepting a user command to override a portion of the automated process.

21. The method of claim 19 where said automated process includes automatically generating a simulation route related to, but not identical to, said traversed path.

22. The method of claim 9 where obtaining said simulation route includes:
(i) accepting a user-specified sequence of locations to be visited; and
(ii) calculating said simulation route by curve-fitting said specified sequence of locations.

23. The method of claim 9 further comprising accessing information about multiple paths for use in said simulation.

24. The method of claim 9 further comprising displaying simulation information to multiple users.

25. The method of claim 22 further comprising facilitating said multiple users to interact with each other during said simulation.

26. A computer-readable medium, for enabling a three-dimensional simulation through a region, comprising logic instructions that when executed:
obtain information about a path traversed by a user through a region, including a plurality of locations on said path;
acquire content associated with at least some of said locations;
correlate said locations with said content; and
enable an interactive three-dimensional simulation of travel through said region as experienced from a moving vantage point along a simulation route, including:
access a three-dimensional map for at least a portion of said region; and
associate said acquired content to locations on said three-dimensional map based on said correlation.

27. The computer-readable medium of claim 26 where said simulation route is different than said traversed path.

28. The computer-readable medium of claim 26 where said simulation route is at least partially user-specified.

29. The computer-readable medium of claim 26 where said simulation route is at least partially automatically generated.

30. The computer-readable medium of claim 26 where said content represents synthetic content.

31. A computer-readable medium for simulating a trip through a region, from a three-dimensional vantage point, comprising logic instructions that when executed:
access information about a path traversed through a region, including a plurality of predetermined locations;
access content associated with at least some of said locations;
access a three-dimensional map of said region;
associate at least some of said content, and at least some of said locations, on said map;
determine a simulation route through said region; and
display to a user an interactive simulation along said simulation route, including presenting content along said simulation route, as experienced from a moving vantage point.

32. The computer-readable medium of claim 31 including modifying at least a portion of said simulation route to avoid collision with at least some of said content during said simulation.

33. The computer-readable medium of claim 31 further comprising executing at least one automated process, for performing a user-specified interactive simulation aspect that would otherwise be inconvenient for the user to implement manually.

34. The computer-readable medium of claim 31 further comprising facilitating multiple users' interaction with each other during said simulation.

35. Apparatus for enabling a three-dimensional simulation through a region, comprising:
means for obtaining information about a path traversed by a user through a region, including a plurality of locations on said path;
means for acquiring content associated with at least some of said locations;
means for correlating said locations with said content; and
means for enabling an interactive three-dimensional simulation through said region as experienced from a moving vantage point along a simulation route, including:
means for accessing a three-dimensional map for at least a portion of said region; and
means for associating said acquired content to locations on said three-dimensional map based on said correlation.

36. Apparatus for simulating a trip through a region, from a three-dimensional vantage point, comprising:
means for accessing information about a path traversed through a region, including a plurality of predetermined locations;
means for accessing content associated with at least some of said locations;
means for accessing a three-dimensional map of said region;
means for associating at least some of said content, and at least some of said locations, with said map;
means for determining a simulation route through said region; and
means for displaying to a user an interactive simulation along said simulation route, including presenting content along said simulation route, as experienced from a moving vantage point.
